(19) United States
(12) Patent Application Publication
(10) Pub. No.: US 2019/0232399 A1
(43) Pub. Date: Aug. 1, 2019

(54) FOLDABLE MITER SAW WITH A SAW BLADE LIMITING MEMBER

(71) Applicant: REXON INDUSTRIAL CORP., LTD., Taichung (TW)

(72) Inventor: Wei Chen LIN, Taichung (TW)

(73) Assignee: REXON INDUSTRIAL CORP., LTD., Taichung (TW)

(21) Appl. No.: 16/260,189

(22) Filed: Jan. 29, 2019

(30) Foreign Application Priority Data
Feb. 1, 2018 (TW) 107103631

(51) Int. Cl. B23D 45/04; B27B 5/36; B23D 47/02

(52) U.S. Cl. CPC B23D 45/044; B27G 19/02; B23D 47/025; B27B 5/36

(57) ABSTRACT

A foldable miter saw with a saw blade limiting member includes a base unit, a worktable unit and a cutting unit. The worktable unit is rotatably disposed on the base unit and includes a working surface, an outer ring surface and an axial block. The cutting unit includes a rotatable member disposed on the axial block, a supporting arm pivotally disposed on the rotatable member, and a saw blade and a driving member mounted on the supporting arm. The supporting arm includes an inner side surface and a limiting member which protrudes from the inner side surface towards the outer side. When the cutting unit is in the folded position, an end face of the saw blade is disposed in proximity to the working surface, and the limiting member is disposed in proximity of the outer ring surface and between the top surface and the bottom surface.

### BACKGROUND OF THE INVENTION

### 1. Field of the Invention

The present invention relates to miter saw technology and more particularly, to a foldable miter saw with a saw blade limiting member.

### 2. Description of the Related Art

There is a miter saw (the prior art of the patent application of the Republic of China Publication No. 201325776), comprising a base unit, a worktable rotatable relative to the base unit, a cutting unit coupled to one side of the worktable, and a positioning unit. The base unit has a base and two feet respectively fixed on both sides of the base. The positioning unit has a shaft screwed on the worktable. When the sawing angle of the cutting unit is to be adjusted, the operator must loosen the shaft, and use the worktable to drive the cutting unit to rotate relative to the base unit. When the cutting unit is turned to the desired angle, the shaft is tightened again.

The above miter saw has an operational functionality of adjusting the sawing angle. However, when the miter saw is not used and needs to be temporarily stored, the overall assembled state is bulky and takes up a large space. Further, when the miter saw is manufactured and is intended to be packed and transported, if it is packaged in an assembled state, it will increase the volume and the handling cost.

In order to solve the above problems, the applicant has invented TW certificate number I593489, I586465, I586494, I577474, where these disclosures teach miter saws that can be stored into smaller volumes according to demand.

However, in the case of a foldable miter saw, the cutting unit is converted between a working position and a folded position relative to the base unit. When the cutting unit is operated to the folded position relative to the base unit, the cutting unit may be vibrated relative to the base unit and may cause the components to collide with each other. This vibration not only can lead to damage of the miter saw, this can also lead to a safety problem, especially the guard of the cutting unit can be hit to open, causing the saw blade to be exposed.

### SUMMARY OF THE INVENTION

The present invention has been developed in view of the circumstances identified above. It is one of the main objects of the present invention to provide a foldable miter saw, which can provide better positioning and prevent the components from colliding with each other.

To achieve this and other objects of the present invention, a foldable miter saw with a saw blade limiting member comprises a base unit, a worktable unit and a cutting unit. The base unit having a front side, a rear side opposite to the front side, a top surface extended from the front side to the rear side and a bottom surface opposite to the top surface. The worktable unit is rotatably mounted on the base unit, having a work surface corresponding to the top surface, an outer ring surface intersected with the perimeter of the work surface, and an axle block located at the rear side and connected to the work surface and the outer ring surface. The axle block having an axis that parallel to the work surface and extends from the rear side toward the front side. The cutting unit having a rotatable member axially mounted in the axle block and rotatable around the axis relative to the worktable unit, a supporting arm pivotally connected to the rotatable member, a saw blade mounted on the supporting arm, and a driving member mounted on the supporting arm for driving the saw blade to rotate, such as a motor. The supporting arm having an inner surface corresponded to or facing towards the work surface, an outer surface opposite to the inner surface, and a limiting member that protrudes from the inner surface towards opposite to the outerside of the outer surface. The saw blade having two opposing end faces and is biasable relative to the worktable unit between an extended working position where the saw blade and the work surface define therebetween a working contained angle and the limiting member is disposed above the axle block, and a folded position where one end face of the saw blade is disposed in proximity to the work surface and the limiting member is disposed in proximity to the outer ring surface between the top surface and the bottom surface.

The effect of the present invention is that when the cutting unit is in the folded position, the limiting member stops the cutting unit in a position relative to the base unit and the worktable unit, prohibiting the cutting unit from vibrating and avoiding damage of the parts from them colliding with each other. By utilizing the limiting member the cutting unit will generate a stopping position relative to the base unit and the worktable unit, therefore, the cutting unit is accordingly prevented from vibration.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a foldable miter saw in an extended working position in accordance with the present invention.

FIG. 2 is an exploded view of the foldable miter saw in accordance with the present invention.

FIG. 3 is an elevational view of the present invention, illustrating the cutting unit in the folded position.

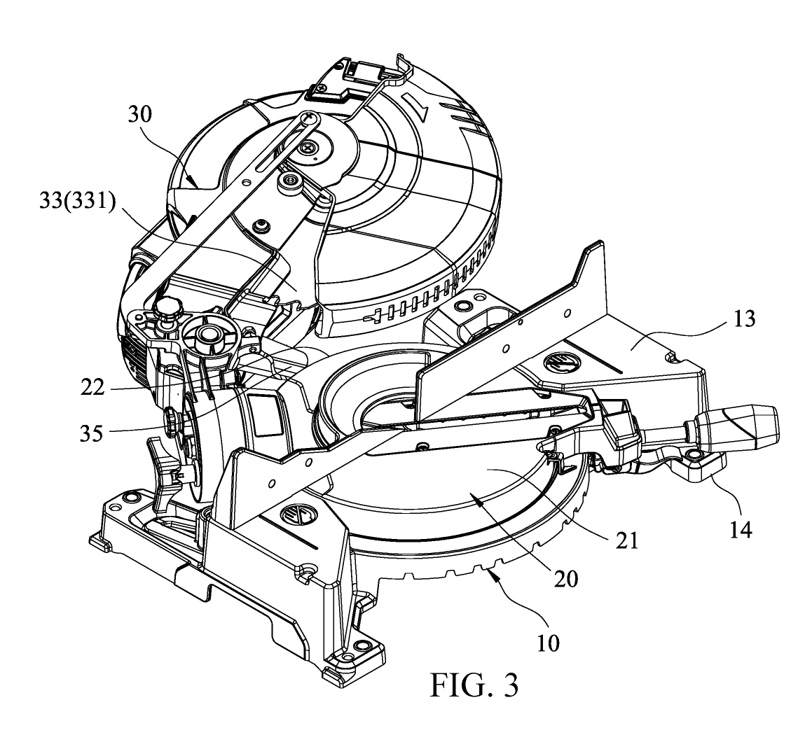

FIG. 4 is a top view of the present invention, illustrating the cutting unit in the folded position.

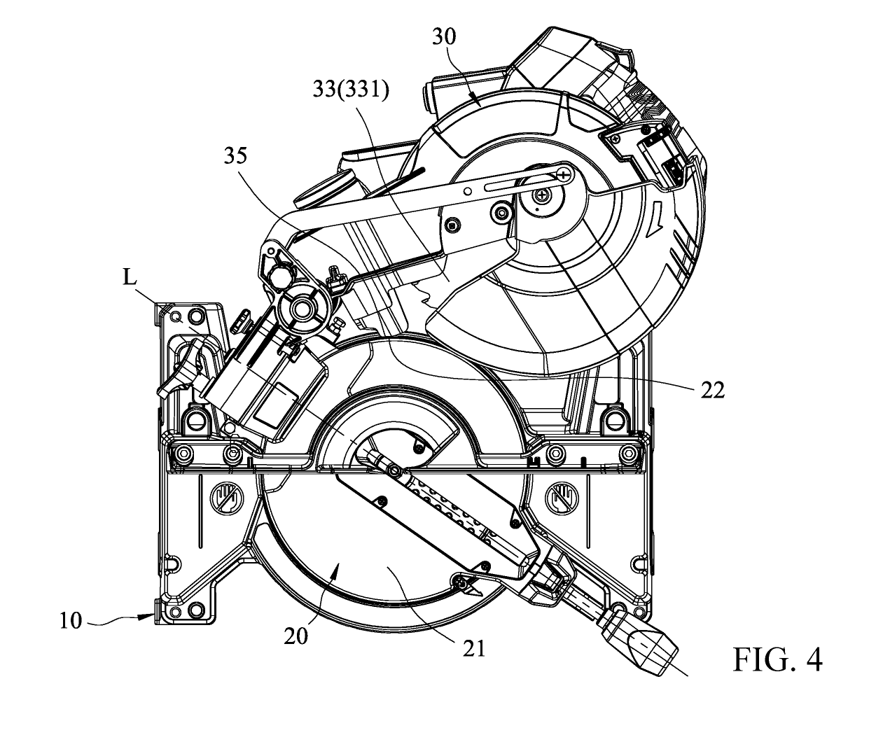

FIG. 5 is a right-side view of the present invention, illustrating the cutting unit in the folded position.

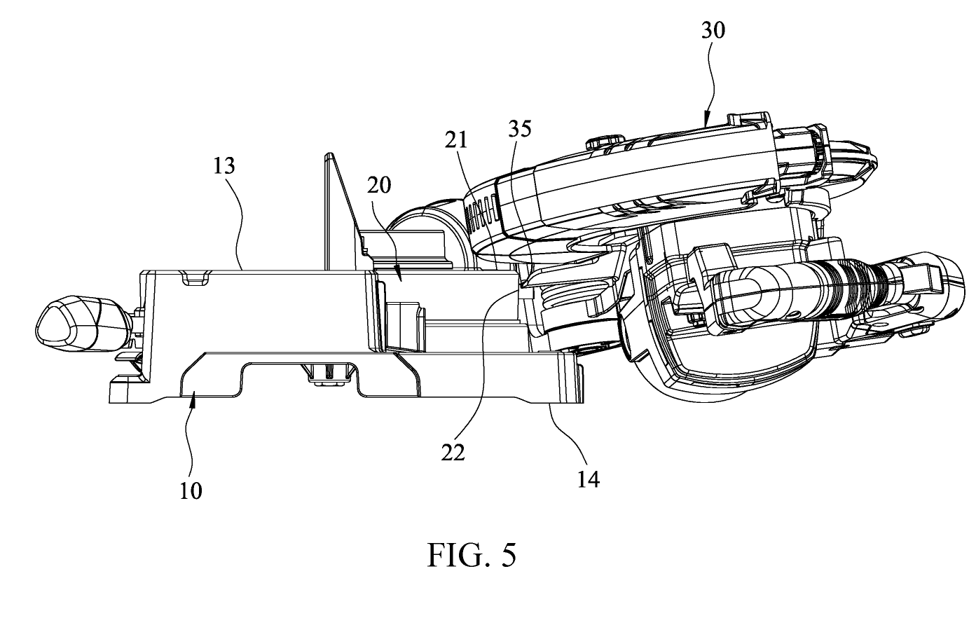

### DETAILED DESCRIPTION OF THE INVENTION

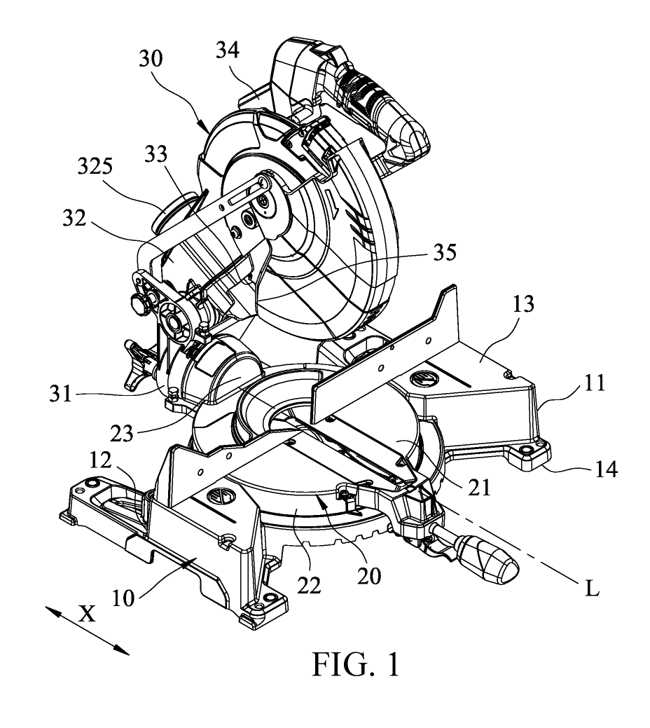

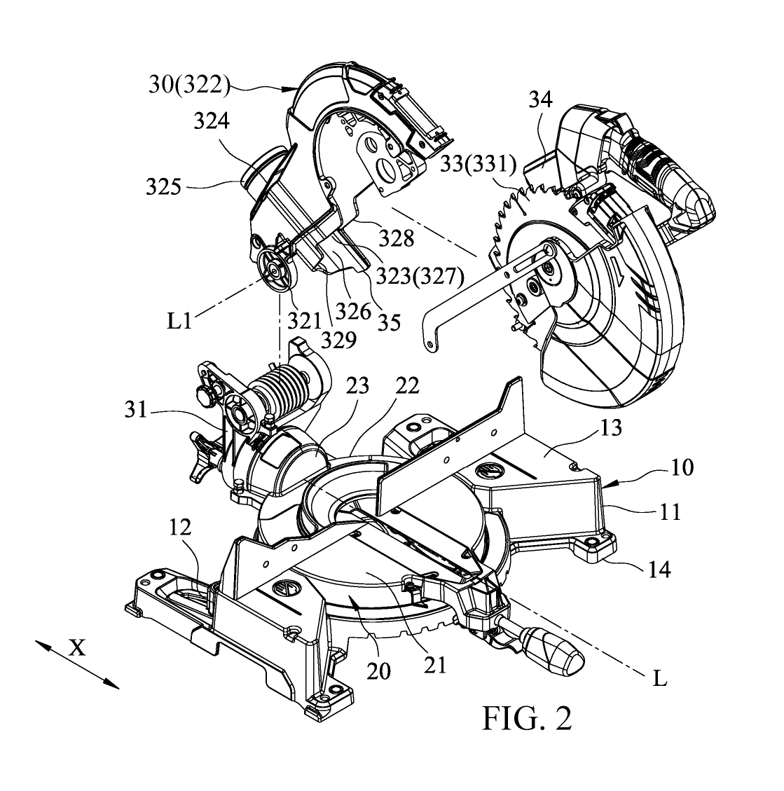

Referring to FIGS. 1 and 2, a foldable miter saw in accordance with the present invention is shown. The foldable miter saw comprises a base unit 10, a worktable unit 20 and a cutting unit 30.

The base unit 10 has a front side 11, a rear side 12 opposite to the front side 11, a top surface 13 extended from the front side 11 to the rear side 12, and a bottom surface 14 opposite to the top surface 13.

The worktable unit 20 is rotatably mounted on the base unit 10, comprising a work surface 21 corresponding to the top surface 13 of the base unit 10, an outer ring surface 22 that intersects the perimeter of the work surface 21, and an axle block 23 located at the rear side 12 and connected to the work surface 21 and the outer ring surface 22. The axle block 23 defines an axis L that extends from the rear side 12 toward the front side 11 in a parallel manner relative to the work surface 21.

The cutting unit 30 comprises a rotatable member 31 axially mounted to the axle block 23 and rotatable on the axis L relative to the worktable unit 20, a supporting arm 32 pivotally connected to the rotatable member 31, a saw blade 33 mounted in the supporting arm 32, and a driving member 34, such as a motor, mounted on the supporting arm 32 and adapted for rotating the saw blade 33.

The supporting arm 32 comprises two pivot discs 321 spaced along a center line L1 and axially mounted to the rotatable member 31, a shell cover 322 connected to the pivot discs 321, and a limiting member 35 located on the shell cover 322. The center line L1 extends perpendicular to the axis L. The shell cover 322 defines an inner surface 323 facing toward the work surface 21, an outer surface 324 opposite to the inner surface 323, and a dust collector 325 disposed adjacent to the pivot discs 321 and extended from the inner surface 323 toward the outer surface 324. The dust collector 325 is a tubular member having a dust collecting hole 326 extending along a transverse axis direction X that extends perpendicular to the center line L1, a U-shaped cross section perpendicular to the transverse axis direction X, a first lateral side 327 facing toward one pivot disc 321, a second lateral side 328 facing toward the other pivot disc 321, and an arch plate portion 329 connected between the first lateral side 327 and the second lateral side 328. The limiting member 35 is connected to the second lateral side 328 of the dust collector 325 and protrudes outwardly from the inner surface 323 opposite the outer surface 324.

The saw blade 33 is mounted on the other end of the shell cover 322 opposite to the pivot discs 321 and defines two opposing end faces 331.

The driving member 34 is installed in the shell cover 322 corresponding to the saw blade 33.

FIG. 1 shows the cutting unit of the miter saw in an extended position. At this time, the saw blade 33 and the work surface 21 define therebetween a working contained angle; the limiting member 35 is disposed above the axle block 23; the saw blade 33 is operable to cut a workpiece (not shown).

When the miter saw is not used and is intended to be stored or packaged, the operator can operate the worktable unit 20 to rotate the cutting unit 30 by 45 degrees to the left side of FIG. 1 with respect to the base unit 10, then rotate the cutting unit 30 along the axis L to move one end face 331 of the saw blade 33 in proximity to the work surface 21. At this time, the cutting unit 30 reaches a folded position, and the outer ring surface 22 is disposed between the top surface 13 and the bottom surface 14.

Thus, when the cutting unit 30 is in the folded position, the end edge of the limiting member 35 is disposed in proximity to the outer ring surface 22 between the top surface 13 and the bottom surface 14 so that the end edge of the limiting member 35 can block the outer ring surface 22. In so doing, even if the miter saw is vibrated during transportation, the cutting unit 30 is prevented from vibrating, avoiding the damage of the parts from colliding with each other and further preventing the guard of the cutting unit 30 from being knocked open, which prevents the saw blade 33 from being exposed to ensure safety.

It should be noted that, in this embodiment, the limiting member 35 is integrally connected to the dust collector 325 of the miter saw, so that the limiting member 35 is not required to be separately manufactured and assembled. When the cutting unit 30 is folded, it is held positively in position relative to the base unit 10 and the worktable unit 20. The overall structure of the miter saw is simple and easy to manufacture, and the manufacturing cost can be reduced.

In summary, the foldable miter saw of the present invention has a simple overall structure that is easy to manufacture, so that the object of the present invention can be achieved.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A foldable miter saw with a saw blade limiting member, comprising:
a base unit comprising a front side, a rear side opposite to said front side, a top surface extended from said front side to said rear side and a bottom surface opposite to said top surface;
a worktable unit rotatably mounted on said base unit, said worktable unit comprising a work surface corresponding to said top surface, an outer ring surface intersected with a perimeter of said work surface and an axle block located at said rear side and connected to said work surface and said outer ring surface, said axle block comprising an axis parallel to said work surface and extends from said rear side toward said front side; and
a cutting unit comprising a rotatable member axially mounted on said axle block and rotatable around said axis relative to said worktable unit, a supporting arm pivotally connected to said rotatable member, a saw blade mounted on said supporting arm and a driving member mounted on said supporting arm for driving said saw blade to rotate, said supporting arm comprising an inner surface facing toward said work surface, an outer surface opposite to said inner surface and a limiting member that protrudes from said inner surface towards opposite to the outerside of said outer surface, said saw blade comprising two opposing end faces and being biasable relative to said worktable unit between a working position and a folded position, wherein when said saw blade is in the working position, said saw blade and said work surface define therebetween a working contained angle and said limiting member is disposed above said axle block, and wherein when said saw blade is in the folded position, one of said end face of said saw blade is disposed in proximity to said work surface and said limiting member is disposed in proximity to said outer ring surface between said top surface and said bottom surface.

2. The foldable miter saw with a saw blade limiting member as claimed in claim 1, wherein said supporting arm of said cutting unit comprises two pivot discs spaced along a center line and axially mounted to said rotatable member and a shell cover connected to said pivot discs, said center line extending perpendicular to said axis, said saw blade and said driving member are mounted on said shell cover, said shell cover comprising a dust collector disposed adjacent to said pivot discs, said dust collector being a tubular shape comprising a dust collection hole extended along a transverse axis direction perpendicular to said center line; wherein said limiting member is mounted on said dust collector.

3. The foldable miter saw with a saw blade limiting member as claimed in claim 2, wherein said dust collector of said cutting unit has a U-shaped cross section perpendicular to said transverse axis direction, a first lateral side corresponding to one said pivot discs, a second lateral side corresponding to the other said pivot disc and an arch plate portion connected between said first lateral side and said second lateral side; wherein said limiting member is connected to said second lateral side.
